(19) United States
(12) Patent Application Publication
(10) Pub. No.: US 2024/0218107 A1
(43) Pub. Date: Jul. 4, 2024

(54) Composition of thermoplastic polyurethane and polyamide

(71) Applicant: ARKEMA FRANCE, COLOMBES (FR)

(72) Inventors: Thomas PRENVEILLE, Serquigny (FR); Florent ABGRALL, Serquigny (FR)

(73) Assignee: ARKEMA FRANCE, COLOMBES (FR)

(21) Appl. No.: 18/556,056

(22) PCT Filed: Apr. 22, 2022
(86) PCT No.: PCT/FR2022/050772

§ 371 Date: Oct. 18, 2023

(30) Foreign Application Priority Data
Apr. 22, 2021 (FR) FR2104204

(51) Int. Cl. C08G 18/12; B29C 45/00; B29K 75/00; B29K 77/00; C08G 18/32; C08G 18/42; C08G 69/48; C08L 75/06; C08L 77/02; C08L 77/06; C08L 87/00

(52) U.S. Cl. CPC C08G 18/12; B29C 45/0001; C08G 18/3206; C08G 18/4238; C08G 69/48; C08L 75/06; C08L 77/02; C08L 77/06; C08L 87/005; B29K 2075/00; B29K 2077/00; C08G 2410/00; C08L 2205/03

(57) ABSTRACT

A composition including at least one thermoplastic polyurethane and at least one polyamide comprising amine chain ends, wherein the polyamide is the reaction product of one or more monomers chosen from amino acids or aminocarboxylic acids, lactams and monomers resulting from the reaction between an aliphatic diamine and a dicarboxylic acid. Also, a composition obtained by the reaction of at least one thermoplastic polyurethane or thermoplastic polyurethane precursors and of at least one polyamide comprising amine chain ends, processes for preparing such compositions and articles made therefrom.

### TECHNICAL BACKGROUND

Various polymer compositions are used notably in the field of sports equipment, such as soles or sole components, gloves, rackets or golf balls, or personal protective items in particular for practising sports (jackets, interior parts of helmets, shells, etc.). Such applications require a set of particular physical properties which ensure rebound capacity, a low compression set or tensile set and a capacity for enduring repeated impacts and for returning to the initial shape. The polymer compositions are also used, for example, in the field of medical equipment, such as catheters, or in other fields (for example for watch straps, toys or industrial applications, in particular for production line conveyor belts).

Documents U.S. Pat. No. 7,383,647 and EP 1871188 relate to footwear midsoles which may comprise one or more components made of thermoplastic polyurethane (TPU), polyester-TPU, polyether-TPU, polyester-polyether TPU, polyvinyl chloride, polyester, thermoplastic ethyl vinyl acetate, styrene-butadiene-styrene, block polyetheramide, technical polyester, TPU blends comprising natural and synthetic rubbers, or combinations thereof.

Document FR 2831175 relates to a composition comprising a mixture of at least two thermoplastic polyurethanes and a compatibilizing agent in an amount less than or equal to 15%, the compatibilizing agent preferably being a polyetheramide, a polyesteramide or a polyetheresteramide.

Document JP 5393036 describes a thermoplastic resin composition comprising a thermoplastic resin and an antistatic agent containing a polyetheresteramide and a polyurethane-based thermoplastic elastomer.

Document JP 5741139 describes a polyurethane resin composition comprising a thermoplastic polyurethane resin and a copolymer containing polyamide blocks and polyether blocks, prepared by dry blending of the components, wherein the copolymer containing polyamide blocks and polyether blocks is formed by polymerizing a triblock polyether diamine, a dicarboxylic acid and a polyamide-forming monomer.

There is a real need to provide a composition having good tear strength, high elasticity, low density and satisfactory flexibility.

### SUMMARY OF THE INVENTION

The invention relates firstly to a composition comprising:
at least one thermoplastic polyurethane, and
at least one polyamide comprising amine chain ends,
   wherein the polyamide is the reaction product of one or more monomers chosen from amino acids or aminocarboxylic acids, lactams and monomers resulting from the reaction between an aliphatic diamine and a dicarboxylic acid.

The invention also relates to a composition obtained by the reaction of:
at least one thermoplastic polyurethane or thermoplastic polyurethane precursors, and
at least one polyamide comprising amine chain ends,
   wherein the polyamide is the reaction product of one or more monomers chosen from amino acids or aminocarboxylic acids, lactams and monomers resulting from the reaction between an aliphatic diamine and a dicarboxylic acid.

In embodiments, at least one portion of the polyamide is covalently bonded to at least one portion of the thermoplastic polyurethane by a urea function, the concentration of urea functions in the composition preferably being from 0.001 meq/g to 0.1 meq/g, more preferably from 0.003 meq/g to 0.08 meq/g, more preferably from 0.005 meq/g to 0.05 meq/g.

In embodiments, the polyamide has a concentration of NH₂ amine functions of from 0.02 meq/g to 2.0 meq/g, preferably from 0.04 meq/g to 1.5 meq/g.

In embodiments, the composition has a tensile modulus at 23° C. of less than or equal to 1000 MPa, preferably less than or equal to 800 MPa.

In embodiments, the composition further comprises at least one copolymer containing polyamide blocks and polyether blocks, preferably the polyamide blocks of the copolymer being chosen from polyamide 6, polyamide 6.10, polyamide 6.12, polyamide 11, polyamide 10 and/or polyamide 12 blocks, and/or the polyether blocks of the copolymer being polyethylene glycol and/or polytetrahydrofuran blocks.

In embodiments, the at least one polyamide comprising amine chain ends is present in an amount of less than or equal to 40% by weight, preferably less than or equal to 30% by weight, relative to the total weight of the composition.

In embodiments, the composition comprises, relative to the total weight of the composition:
from 10% to 99% by weight, preferably from 15% to 89% by weight, of at least one thermoplastic polyurethane,
from 1% to 40% by weight, preferably from 1% to 30% by weight, of at least one amine-terminated polyamide with chain ends, and
from 0 to 89%, preferably from 10% to 70%, by weight, of at least one copolymer containing polyamide blocks and polyether blocks.

In embodiments, the composition has a tan δ at 23° C. of less than or equal to 0.18, preferably less than or equal to 0.16.

In embodiments, the polyamide comprising amine chain ends has a number-average molar mass of from 1000 to 60 000 g/mol, preferably from 2000 to 40 000 g/mol.

In embodiments, the thermoplastic polyurethane is a copolymer containing rigid blocks and flexible blocks, wherein:
the flexible blocks are chosen from polyether blocks, polyester blocks, polycarbonate blocks and a combination thereof; preferably, the flexible blocks are chosen from polyether blocks, polyester blocks, and a combination thereof, and are more preferentially polytetrahydrofuran blocks, polypropylene glycol blocks and/or polyethylene glycol blocks; and/or
the rigid blocks comprise units derived from diphenylmethane-4,4′-diisocyanate and/or from hexamethylene-1,6-diisocyanate and, preferably, units derived from at least one chain extender chosen from 1,3-propanediol, 1,4-butanediol and/or 1,6-hexanediol.

In embodiments, the polyamide comprising amine chain ends is chosen from the group consisting of polyamide 11, polyamide 12, polyamide 10, polyamide 6, polyamide 6.10, polyamide 6.6, polyamide 10.10, polyamide 10.12 and combinations thereof.

The invention also relates to a process for preparing a composition, comprising the following steps:
mixing, preferably in an extruder, at least one polyamide comprising amine chain ends in the melt state, at least one thermoplastic polyurethane in the melt state and optionally at least one copolymer containing polyamide blocks and polyether blocks in the melt state, the polyamide comprising amine chain ends being the reaction product of one or more monomers chosen from amino acids or aminocarboxylic acids, lactams and monomers resulting from the reaction between an aliphatic diamine and a dicarboxylic acid; and
optionally, shaping the mixture in the form of granules or powder.

The invention also relates to a process for preparing a composition, comprising the following steps:
introducing into a reactor, preferably an extruder, precursors of at least one thermoplastic polyurethane;
introducing into the reactor at least one polyamide comprising amine chain ends and optionally at least one copolymer containing polyamide blocks and polyether blocks, the polyamide comprising amine chain ends being the reaction product of one or more monomers chosen from amino acids or aminocarboxylic acids, lactams and monomers resulting from the reaction between an aliphatic diamine and a dicarboxylic acid;
synthesizing the thermoplastic polyurethane in the reactor in the presence of the polyamide comprising amine chain ends, so as to obtain a composition made of thermoplastic polyurethane and of polyamide;
optionally, shaping the composition in the form of granules or powder.

The invention also relates to an article consisting of, or comprising at least one element consisting of, a composition as described above, said article preferably being chosen from sports footwear soles, large or small balls, gloves, personal protective equipment, tie pads, motor vehicle parts, structural parts, optical equipment parts, electrical and electronic equipment parts, watch straps, toys, medical equipment parts such as catheters, transmission or conveyor belts, gears and production line conveyor belts.

The invention also relates to a process for manufacturing an article as described above, comprising the following steps:
supplying a composition as described above;
injection molding said composition.

The present invention makes it possible to meet the need expressed above. More particularly, it provides a composition having a relatively low density and exhibiting high elasticity, satisfactory flexibility and high tear strength and durability.

This is achieved through the combination of a thermoplastic polyurethane (or TPU) and a polyamide (or PA) having amine (NH₂) chain ends.

In certain advantageous embodiments, a reaction occurs between at least a portion of the polyamide comprising amine chain ends and at least a portion of the thermoplastic polyurethane, and more particularly between the amine functions of the polyamide and the urethane functions of the thermoplastic polyurethane or the isocyanate functions present in the precursors of the thermoplastic polyurethane. This reaction between at least a portion of the polyamide comprising amine chain ends and at least a portion of the thermoplastic polyurethane provides better compatibility between these polymers. This results in an improvement in the properties of the blends thus obtained, and in particular in the properties mentioned above.

### DETAILED DESCRIPTION

The invention is now described in more detail and in a non-limiting way in the description which follows.

The invention relates to a composition comprising at least one thermoplastic polyurethane and at least one polyamide having amine chain ends. In the present text, the terms “chain end” and “end of chain” have the same meaning and may be used interchangeably.

Polyamide (PA) with Amine Chain Ends

The polyamide with amine chain ends may be a homopolyamide and/or a copolyamide.

The term “polyamide” means the products of polymerization of one or more monomers chosen from:
monomers of amino acid or aminocarboxylic acid type, and preferably alpha,omega-aminocarboxylic acids, preferably having from 6 to 14 carbon atoms;
monomers of lactam type preferably having from 3 to 18 carbon atoms in the main ring and which may be substituted;
monomers of “diamine.diacid” type resulting from the reaction between an aliphatic diamine preferably having from 2 to 48 carbon atoms, more preferentially from 2 to 20 carbon atoms, and a dicarboxylic acid preferably having from 4 to 48 carbon atoms, more preferentially from 4 to 20 carbon atoms; and
mixtures thereof, with monomers containing a different carbon number in the case of mixtures between a monomer of amino acid type and a monomer of lactam type.

In the present description of the polyamides, the term “monomer” should be taken to mean “repeating unit”. Indeed, a special case is where a repeating unit of the polyamide (PA) consists of the combination of a diacid with a diamine. It is considered that it is the combination of a diamine and a diacid, that is to say the diamine.diacid pair (in an equimolar amount), which corresponds to the monomer. This is explained by the fact that, individually, the diacid or the diamine is only a structural unit, which is not enough in itself alone to be polymerized.

For the purposes of the present invention, the polyamide with amine chain ends consists solely of polyamide. In particular, it does not comprise any block of another type, such as, for example, a polyether block, polyester block, polysiloxane block, polyolefin block or polycarbonate block. More particularly, the polyamide with amine chain ends is not a copolymer containing polyamide blocks and polyether blocks. The composition according to the invention may comprise a polyamide, with or without amine chain ends, comprising a block other than a polyamide block, provided that it also comprises a polyamide with amine chain ends consisting solely of polyamide.

When the polyamide is a homopolyamide, it is the product of polymerization of a single monomer. When the polyamide is a copolyamide, it is the product of polymerization of at least two different monomers.

Advantageously, three types of polyamides may be used.

According to a first type, the polyamides originate from the condensation of a dicarboxylic acid, in particular those having from 4 to 48 carbon atoms, preferably those having from 4 to 20 carbon atoms, more preferentially from 6 to 18 carbon atoms, and of an aliphatic or aromatic diamine, in particular those having from 2 to 48 carbon atoms, preferably those having from 2 to 20 carbon atoms, more preferentially from 5 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of ethylenediamine, tetramethylenediamine, pentamethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamides PA 4.12, PA 4.14, PA 4.18, PA 5.10, PA 5.12, PA 5.14, PA 5.16, PA 5.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues and Y represents the number of carbon atoms derived from the diacid residues, as is conventional.

According to a second type, the polyamides result from the condensation of one or more α,ω-aminocarboxylic acids and/or of one or more lactams having from 3 to 18 carbon atoms, preferably from 6 to 14 carbon atoms, in the presence of a dicarboxylic acid having from 2 to 48 carbon atoms, preferably from 4 to 20 carbon atoms, or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 10-aminodecanoic acid, 11-aminoundecanoic acid and 12-aminododecanoic acid.

Advantageously, the polyamides of the second type are PA 10 (polydecanamide), PA 11 (polyundecanamide), PA 12 (polydodecanamide) or PA 6 (polycaprolactam). In the notation PA X, X represents the number of carbon atoms derived from amino acid residues.

According to a third type, the polyamides result from the condensation of at least one α,ω-aminocarboxylic acid (or a lactam), at least one diamine and at least one dicarboxylic acid.

In this case, the polyamides PA are prepared by polycondensation:
of the linear aliphatic or aromatic diamine(s) having X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y),
said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamides result from the condensation of at least two α,ω-aminocarboxylic acids or of at least two lactams containing from 6 to 12 carbon atoms or of one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 10-aminodecanoic acid, 11-aminoundecanoic acid and 12-aminododecanoic acid. As examples of lactams, mention may be made of caprolactam, oenantholactam and lauryllactam. As examples of aliphatic diamines, mention may be made of pentamethylenediamine, hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by the company Croda, or under the brand name Empol by the company BASF, or under the brand name Radiacid by the company Oleon, and polyoxyalkylene α,ω-diacids. As examples of aromatic diacids, mention may be made of terephthalic acid (T) and isophthalic acid (1). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamides of the third type, mention may be made of the following:
PA 6.6/6, where 6.6 denotes hexamethylenediamine units condensed with adipic acid and 6 denotes units resulting from the condensation of caprolactam;
PA 6.6/6.10/11/12, where 6.6 denotes hexamethylenediamine condensed with adipic acid, 6.10 denotes hexamethylenediamine condensed with sebacic acid, 11 denotes units resulting from the condensation of aminoundecanoic acid, and 12 denotes units resulting from the condensation of lauryllactam.

The notations PA X/Y, PA X/Y/Z, etc. relate to copolyamides wherein X, Y, Z, etc. represent homopolyamide units as described above.

Advantageously, the polyamide used in the invention comprises or consists of a polyamide PA 6, PA 10, PA 11, PA 12, PA 5.4, PA 5.9, PA 5.10, PA 5.12, PA 5.13, PA 5.14, PA 5.16, PA 5.18, PA 5.36, PA 6.4, PA 6.6, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, or mixtures or copolymers thereof; and preferably comprises or consists of a polyamide PA 6, PA 10, PA 11, PA 12, PA 6.6, PA 6.10, PA 10.10, PA 10.12, or mixtures or copolymers thereof.

Preferably, the amide bonds of the polyamide are free of tertiary amides (that is to say amides in which the amine is a tertiary amine). More preferentially, all the amide bonds of the polyamide are secondary amides (that is to say that the amines of the amide bonds are secondary amines).

The polyamide comprising amine chain ends advantageously has a number-average molar mass of from 1000 to 60 000 g/mol, preferably from 2000 to 40 000 g/mol, very advantageously from 2000 to 18 000 g/mol. In embodiments, the polyamides with amine chain ends may have a number-average molar mass of from 1000 to 2000 g/mol; or from 2000 to 3000 g/mol; or from 3000 to 5000 g/mol; or from 5000 to 10 000 g/mol; or from 10 000 to 15 000 g/mol; or from 15 000 to 20 000 g/mol; or from 20 000 to 25 000 g/mol; or from 25 000 to 30 000 g/mol; or from 30 000 to 35 000 g/mol; or from 35 000 to 40 000 g/mol; or from 40 000 to 45 000 g/mol; or from 45 000 to 50 000 g/mol; or from 50 000 to 55 000 g/mol; or from 55 000 to 60 000 g/mol.

The number-average molar mass is set by the content of chain limiter. It may be calculated according to the equation:

$${M}_{n} = {n}_{monomer} \times {MW}_{repeating unit} / {n}_{chain limiter} + {MW}_{chain limiter}$$

In this formula, nₘₒₙₒₘₑᵣ represents the number of moles of monomer, n_{chain} limiter represents the number of moles of diacid limiter in excess, MW_{repeating unit} represents the molar mass of the repeating unit, and MW_{chain limiter} represents the molar mass of the diacid in excess.

The number-average molar mass of the polyamide can be measured by gel permeation chromatography (GPC).

Preferably, at least 50% by weight of the polyamide comprising amine chain ends (relative to the total weight of the polyamide comprising amine chain ends) has a molar mass of less than or equal to 18 000 g/mol, more preferentially from 50% to 80% by weight of the polyamide comprising amine chain ends has a molar mass of less than or equal to 18 000 g/mol. These amounts of polyamide can be determined by GPC. These ranges make it possible to obtain better elasticity and better elongation at break of the composition.

The polyamide comprising amine chain ends may be monofunctional (that is to say it comprises a single amine chain end per molecule of PA) or it may be difunctional (that is to say it comprises two amine chain ends per molecule of PA); it is preferably monofunctional.

The polyamide preferably has a concentration of amine (NH₂) functions of from 0.02 meq/g to 2.0 meq/g, preferably from 0.04 meq/g to 1.5 meq/g, more preferably from 0.1 to 1.5 meq/g, more preferably from 0.35 to 1.5 meq/g. In particular, the polyamide having amine chain ends may have a concentration of NH₂ functions of from 0.02 to 0.04 meq/g, or from 0.04 to 0.06 meq/g, or from 0.06 to 0.08 meq/g, or from 0.08 to 0.1 meq/g, or from 0.1 to 0.2 meq/g, or from 0.2 to 0.3 meq/g, or from 0.3 to 0.4 meq/g, or from 0.4 to 0.5 meq/g, or from 0.5 to 0.6 meq/g, or from 0.6 to 0.7 meq/g, or from 0.7 to 0.8 meq/g, or from 0.8 to 0.9 meq/g, or from 0.9 to 1.0 meq/g, or from 1.0 to 1.1 meq/g, or from 1.1 to 1.2 meq/g, or from 1.2 to 1.3 meq/g, or from 1.3 to 1.4 meq/g, or from 1.4 to 1.5 meq/g, or from 1.5 to 1.6 meq/g, or from 1.6 to 1.7 meq/g, or from 1.7 to 1.8 meq/g, or from 1.8 to 1.9 meq/g, or from 1.9 to 2.0 meq/g. The concentration of NH₂ functions can be measured by potentiometric titration. This titration may for example be carried out in the following manner: the PAs are first dissolved in m-cresol at 80° C. and then the terminal NH₂ functions are titrated with a perchloric acid solution.

The polyamide comprising amine chain ends may have a concentration of COOH functions of from 0.002 meq/g to 0.2 meq/g, preferably from 0.005 meq/g to 0.1 meq/g, more preferably from 0.01 meq/g to 0.08 meq/g. In particular, the polyamide according to the invention may have a concentration of COOH functions of from 0.002 to 0.005 meq/g, or from 0.005 to 0.01 meq/g, or from 0.01 to 0.02 meq/g, or from 0.02 to 0.03 meq/g, or from 0.03 to 0.04 meq/g, or from 0.04 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.15 meq/g, or from 0.15 to 0.2 meq/g. The concentration of COOH functions can be determined by potentiometric analysis. A measurement protocol is described in detail in the article “Synthesis and characterization of poly(copolyethers-block-polyamides)—II. Characterization and properties of the multiblock copolymers”, Maréchal et al., Polymer, Volume 41, 2000, 3561-3580.

The above concentrations (of amine and COOH functions) correspond to the concentrations of the polyamides comprising amine chain ends taken in their entirety (that is to say, when the composition comprises several polyamides comprising amine chain ends, all of these polyamides are considered).

The polyamides comprising amine chain ends can be prepared by condensation of the polyamide precursors (that is to say of the monomers as described above). Advantageously, the addition of a diamine chain limiter makes it possible to increase the concentration of amine chain ends in the polyamide. The molar ratio of the NH₂ amine functions to the COOH functions of all the monomers charged to the reactor during the synthesis of the polyamide makes it possible to determine the concentration of amine chain ends in the polyamide.

The molar ratio of the NH₂ amine functions to the COOH functions is advantageously from 0.7 to 1.3, preferentially from 0.85 to 1.25.

The polyamide comprising amine chain ends is advantageously semicrystalline. Preferably, it has an enthalpy of melting of greater than 5 J/g. The enthalpy of melting can be measured by differential scanning calorimetry (DSC) analysis according to the standard ISO 11357-3 Plastics—Differential scanning calorimetry (DSC) Part 3.

### Thermoplastic Polyurethane (TPU)

The thermoplastic polyurethane according to the invention is a copolymer with rigid blocks and flexible blocks.

In general, in the present text, the term “rigid block” is understood to mean a block which has a melting point. The presence of a melting point may be determined by differential scanning calorimetry, according to the standard ISO 11357-3 Plastics—Differential scanning calorimetry (DSC) Part 3. The term “flexible block” means a block with a glass transition temperature (Tg) of less than or equal to 0° C. The glass transition temperature may be determined by differential scanning calorimetry, according to the standard ISO 11357-2 Plastics—Differential scanning calorimetry (DSC) Part 2.

The thermoplastic polyurethanes result from the reaction of at least one polyisocyanate with at least one isocyanate-reactive compound, preferably having two isocyanate-reactive functional groups, more preferentially a polyol, and optionally with a chain extender, optionally in the presence of a catalyst. The rigid blocks of the TPU are blocks consisting of units derived from polyisocyanates and chain extenders, while the flexible blocks predominantly comprise units derived from isocyanate-reactive compounds having a molar mass of between 0.5 and 100 kg/mol, preferably polyols.

The polyisocyanate may be aliphatic, cycloaliphatic, araliphatic and/or aromatic. Preferably, the polyisocyanate is a diisocyanate.

Advantageously, the polyisocyanate is chosen from the group consisting of tri-, tetra-, penta-, hexa-, hepta- and/or octamethylene diisocyanate, 2-methylpentamethylene-1,5-diisocyanate, 2-ethylbutylene-1,4-diisocyanate, pentamethylene-1,5-diisocyanate, butylene-1,4-diisocyanate, 1-isocyanato-3,3,5-trimethyl-5-isocyanatomethylcyclohexane (isophorone diisocyanate, IPDI), 1,4-bis(isocyanatomethyl)cyclohexane, 1,3-bis(isocyanatomethyl)cyclohexane (HXDI), paraphenylene-2,4-diisocyanate (PPDI), tetramethylxylene-2,4-diisocyanate (TMXDI), dicyclohexylmethane-4,4′-, 2,4′- and/or 2,2′-diisocyanate (H12 MDI), cyclohexane-1,4-diisocyanate, 1-methylcyclohexane-2,4-diisocyanate and/or 1-methylcyclohexane-2,6-diisocyanate, diphenylmethane-2,2′-, 2,4′—and/or 4,4′-diisocyanate (MDI), naphthylene-1,5-diisocyanate (NDI), toluene-2,4—and/or 2,6-diisocyanate (TDI), diphenylmethane diisocyanate, dimethyldiphenyl-3,3′-diisocyanate, diphenylethane-1,2-diisocyanate, phenylene diisocyanate, methylenebis(4-cyclohexyl isocyanate) (HMDI) and mixtures thereof.

More preferably, the polyisocyanate is chosen from the group consisting of diphenylmethane diisocyanates (MDI), toluene diisocyanates (TDI), pentamethylene diisocyanate (PDI), hexamethylene diisocyanate (HDI), methylenebis(4-cyclohexyl isocyanate) (HMDI) and mixtures thereof.

Even more preferably, the polyisocyanate is 4,4′-MDI (diphenylmethane-4,4′-diisocyanate), 1,6-HDI (hexamethylene-1,6-diisocyanate) or a mixture thereof.

The isocyanate-reactive compound(s) preferably have an average functionality of between 1.8 and 3, more preferably between 1.8 and 2.6, more preferably between 1.8 and 2.2. The average functionality of the isocyanate-reactive compound(s) corresponds to the number of isocyanate-reactive functions of the molecules, calculated theoretically for one molecule from a quantity of compounds. Preferably, the isocyanate-reactive compound has, according to a statistical mean, a Zerewitinoff active hydrogen number within the above ranges.

Preferably, the isocyanate-reactive compound (preferably a polyol) has a number-average molar mass of from 500 to 100 000 g/mol. The isocyanate-reactive compound may have a number-average molar mass of from 500 to 8000 g/mol, more preferably from 700 to 6000 g/mol, more particularly from 800 to 4000 g/mol. In embodiments, the isocyanate-reactive compound has a number-average molar mass of from 500 to 600 g/mol, or from 600 to 700 g/mol, or from 700 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol or from 8000 to 10 000 g/mol, or from 10 000 to 15 000 g/mol, or from 15 000 to 20 000 g/mol, or from 20 000 to 30 000 g/mol, or from 30 000 to 40 000 g/mol, or from 40 000 to 50 000 g/mol, or from 50 000 to 60 000 g/mol, or from 60 000 to 70 000 g/mol, or from 70 000 to 80 000 g/mol, or from 80 000 to 100 000 g/mol. The number-average molar mass may be determined by GPC, preferably according to standard ISO 16014-1:2012.

Advantageously, the isocyanate-reactive compound has at least one reactive group chosen from a hydroxyl group, amine group, thiol group and carboxylic acid group. Preferably, the isocyanate-reactive compound has at least one reactive hydroxyl group, more preferentially several hydroxyl groups. Thus, particularly advantageously, the isocyanate-reactive compound comprises or consists of a polyol.

Preferably, the polyol is chosen from the group consisting of polyester polyols, polyether polyols, polycarbonate diols, polysiloxane diols, polyalkylene diols and mixtures thereof. More preferably, the polyol is a polyether polyol, a polyester polyol and/or a polycarbonate diol, such that the flexible blocks of the thermoplastic polyurethane are polyether blocks, polyester blocks and/or polycarbonate blocks, respectively. More preferably, the flexible blocks of the thermoplastic polyurethane are polyether blocks and/or polyester blocks (the polyol being a polyether polyol and/or a polyester polyol).

As polyester polyol, mention may be made of polycaprolactone polyols and/or copolyesters based on one or more carboxylic acids chosen from adipic acid, succinic acid, pentanedioic acid and/or sebacic acid and on one or more alcohols chosen from 1,2-ethanediol, 1,3-propanediol, 1,4-butanediol, 1,5-pentanediol, 3-methyl-1,5-pentanediol, 1,6-hexanediol and/or polytetrahydrofuran. More particularly, the copolyester may be based on adipic acid and a mixture of 1,2-ethanediol and 1,4-butanediol, or the copolyester may be based on adipic acid, succinic acid, pentanedioic acid, sebacic acid or mixtures thereof, and polytetrahydrofuran (tetramethylene glycol), or the copolyester may be a mixture of these copolyesters.

Polyetherdiols (i.e. aliphatic α,ω-dihydroxyl polyoxyalkylene blocks) are preferably used as polyether polyol. Preferably, the polyether polyol is a polyetherdiol based on ethylene oxide, propylene oxide, and/or butylene oxide, a block copolymer based on ethylene oxide and propylene oxide, a polyethylene glycol, a polypropylene glycol, a polybutylene glycol, a polytetrahydrofuran, a polybutanediol or a mixture thereof. The polyether polyol is preferably a polytetrahydrofuran (flexible blocks of the thermoplastic polyurethane therefore being polytetrahydrofuran blocks) and/or a polypropylene glycol (flexible blocks of the thermoplastic polyurethane therefore being polypropylene glycol blocks) and/or a polyethylene glycol (flexible blocks of the thermoplastic polyurethane therefore being polyethylene glycol blocks), preferably a polytetrahydrofuran having a number-average molar mass of from 500 to 15 000 g/mol, preferably from 1000 to 3000 g/mol. The polyether polyol may be a polyetherdiol which is the reaction product of ethylene oxide and propylene oxide; the molar ratio of the ethylene oxide relative to the propylene oxide is preferably from 0.01 to 100, more preferentially from 0.1 to 9, more preferentially from 0.25 to 4, more preferentially from 0.4 to 2.5, more preferentially from 0.6 to 1.5 and it is more preferentially 1.

The polysiloxane diols which can be used in the invention preferably have a number-average molar mass of from 500 to 15 000 g/mol, preferably of from 1000 to 3000 g/mol. The number-average molar mass may be determined by GPC, preferably according to standard ISO 16014-1:2012. Advantageously, the polysiloxane diol is a polysiloxane of formula (I):

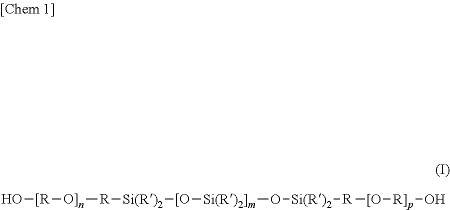

wherein R is preferably a C₂-C₄ alkylene, R′ is preferably C₁-C₄ alkyl and each of n, m and p independently represents an integer preferably between 0 and 50, m more preferably being from 1 to 50, even more preferentially from 2 to 50. Preferably, the polysiloxane has the formula (II) below:

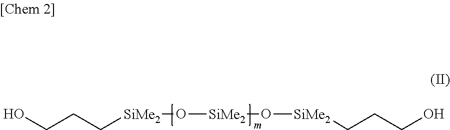

wherein Me is a methyl group,
or the formula (III) below:

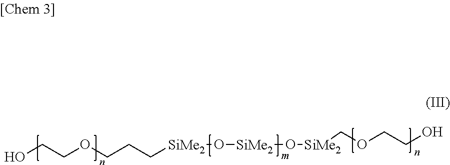

The polyalkylene diols which can be used in the invention are preferably based on butadiene.

The polycarbonate diols which can be used in the invention are preferably aliphatic polycarbonate diols. The polycarbonate diol is preferably based on alkanediol. Preferably, it is strictly bifunctional. The preferred polycarbonate diols according to the invention are those based on butanediol, pentanediol and/or hexanediol, in particular 1,4-butanediol, 1,5-pentanediol, 1,6-hexanediol, 3-methylpentane-(1,5)-diol, or mixtures thereof, more preferentially based on 1,4-butanediol, 1,5-pentanediol, 1,6-hexanediol, or mixtures thereof. In particular, the polycarbonate diol may be a polycarbonate diol based on butanediol and hexanediol, or based on pentanediol and hexanediol, or based on hexanediol, or may be a mixture of two or more of these polycarbonate diols. The polycarbonate diol advantageously has a number-average molar mass of from 500 to 4000 g/mol, preferably from 650 to 3500 g/mol, more preferentially from 800 to 3000 g/mol. The number-average molar mass may be determined by GPC, preferably according to standard ISO 16014-1:2012.

One or more polyols may be used as isocyanate-reactive compound.

Particularly preferably, the flexible blocks of the TPU are blocks of polytetrahydrofuran, polypropylene glycol and/or polyethylene glycol.

Preferably, a chain extender is used for the preparation of the thermoplastic polyurethane, in addition to the isocyanate and the isocyanate-reactive compound.

The chain extender may be aliphatic, araliphatic, aromatic and/or cycloaliphatic. It advantageously has a number-average molar mass of from 50 to 499 g/mol. The number-average molar mass may be determined by GPC, preferably according to standard ISO 16014-1:2012. The chain extender preferably has two isocyanate-reactive groups (also referred to as “functional groups”). It is possible to use a single chain extender or a mixture of at least two chain extenders.

The chain extender is preferably bifunctional. Examples of chain extenders are diamines and alkanediols having from 2 to 10 carbon atoms. In particular, the chain extender may be chosen from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanol cyclohexane, neopentyl glycol, hydroquinone bis(beta-hydroxyethyl) ether (HQEE), di-, tri-, tetra-, penta-, hexa-, hepta-, octa-, nona- and/or deca-alkylene glycol, their respective oligomers, polypropylene glycol and mixtures thereof. More preferentially, the chain extender is chosen from the group consisting of 1,2-ethylene glycol, 1,3-propanediol, 1,4-butanediol, 1,5-pentanediol, 1,6-hexanediol, and mixtures thereof, and more preferably it is chosen from 1,3-propanediol, 1,4-butanediol and/or 1,6-hexanediol. Even more preferentially, the chain extender is a mixture of 1,4-butanediol and 1,6-hexanediol, more preferentially in a molar ratio of 6:1 to 10:1.

Advantageously, a catalyst is used to synthesize the thermoplastic polyurethane. The catalyst makes it possible to accelerate the reaction between the NCO groups of the polyisocyanate and the isocyanate-reactive compound (preferably the hydroxyl groups of the isocyanate-reactive compound) and, if present, with the chain extender.

The catalyst is preferably a tertiary amine, more preferentially chosen from triethylamine, dimethylcyclohexylamine, N-methylmorpholine, N,N′-dimethylpiperazine, 2-(dimethylaminoethoxy)ethanol and/or diazabicyclo-(2,2,2)-octane. Alternatively, or additionally, the catalyst is an organic metal compound such as a titanium acid ester, an iron compound, preferably ferric acetylacetonate, a tin compound, preferably those of carboxylic acids, more preferentially tin diacetate, tin dioctoate, tin dilaurate or dialkyl tin salts, preferably dibutyltin diacetate and/or dibutyltin dilaurate, a bismuth carboxylic acid salt, preferably bismuth decanoate, or a mixture thereof.

More preferably, the catalyst is selected from the group consisting of tin dioctoate, bismuth decanoate, titanium acid esters and mixtures thereof. More preferably, the catalyst is tin dioctoate.

During the preparation of the thermoplastic polyurethane, the molar ratios of the isocyanate-reactive compound and the chain extender can be varied to adjust the hardness and melt flow index of the TPU. Specifically, when the proportion of chain extender increases, the hardness and the melt viscosity of the TPU increases while the melt flow index of the TPU decreases. For the production of flexible TPU, preferably TPU having a Shore A hardness of less than 95, more preferentially from 75 to 95, the isocyanate-reactive compound and the chain extender can be used in a molar ratio of from 1:1 to 1:5, preferably from 1:1.5 to 1:4.5, preferably so that the mixture of isocyanate-reactive compound and chain extender has a hydroxyl equivalent weight of greater than 200, more particularly from 230 to 650, even more preferentially from 230 to 500. For the production of a harder TPU, preferably a TPU having a Shore A hardness of greater than 98, preferably a Shore D hardness of 55 to 75, the isocyanate-reactive compound and the chain extender can be used in a molar ratio of 1:5.5 to 1:15, preferably from 1:6 to 1:12, preferably so that the mixture of isocyanate-reactive compound and chain extender has a hydroxyl equivalent weight of from 110 to 200, more preferentially from 120 to 180.

Advantageously, in order to prepare the TPU, the polyisocyanate, the isocyanate-reactive compound and preferably the chain extender are reacted, preferably in the presence of a catalyst, in amounts such that the equivalent ratio of the NCO groups of the polyisocyanate to the sum of the hydroxyl groups of the isocyanate-reactive compound and the chain extender is from 0.95:1 to 1.10:1, preferably from 0.98:1 to 1.08:1, more preferably from 1:1 to 1.05:1. The catalyst is advantageously present in an amount of 0.0001 to 0.1 parts by weight per 100 parts by weight of the TPU synthesis reagents.

The TPU according to the invention preferably has a weight-average molar mass of greater than or equal to 10 000 g/mol, preferably greater than or equal to 40 000 g/mol and more preferentially greater than or equal to 60 000 g/mol. Preferably, the weight-average molar mass of the TPU is less than or equal to 80 000 g/mol. The weight-average molar masses can be determined by gel permeation chromatography (GPC).

Advantageously, the TPU is semicrystalline. Its melting temperature Tm is preferably between 100° C. and 230° C., more preferably between 120° C. and 200° C. The melting temperature can be measured according to the standard ISO 11357-3 Plastics—Differential scanning calorimetry (DSC) Part 3.

Advantageously, the TPU may be a recycled TPU and/or a partially or completely biobased TPU.

Preferably, the TPU has a Shore D hardness of less than or equal to 75, more preferentially of less than or equal to 65. In particular, the TPU used in the invention may have a hardness of 65 Shore A to 70 Shore D, preferably of 75 Shore A to 60 Shore D. The hardness measurements may be carried out according to the standard ISO 7619-1.

Advantageously, the TPU according to the invention has a concentration of OH functions of from 0.002 meq/g to 0.6 meq/g, preferably from 0.01 meq/g to 0.4 meq/g, more preferably from 0.03 meq/g to 0.2 meq/g. In embodiments, the TPU according to the invention has a concentration of OH functions of from 0.002 to 0.005 meq/g, or from 0.005 to 0.01 meq/g, or from 0.01 to 0.02 meq/g, or from 0.02 to 0.04 meq/g, or from 0.04 to 0.06 meq/g, or from 0.06 to 0.08 meq/g, or from 0.08 to 0.1 meq/g, or from 0.1 to 0.2 meq/g, or from 0.2 to 0.3 meq/g, or from 0.3 to 0.4 meq/g, or from 0.4 to 0.5 meq/g, or from 0.5 to 0.6 meq/g. The concentration of OH functions can be determined by NMR according to the conditions described in the article below: “Reactivity of isocyanates with urethanes: Conditions for allophanate formation”, Lapprand et al., Polymer Degradation and Stability, Volume 90, No. 2, 2005, 363-373.

### Copolymer Containing Polyamide Blocks and Polyether Blocks (PEBA)

The composition according to the invention may also comprise a copolymer containing polyamide blocks and polyether blocks.

The presence of a copolymer containing polyamide blocks and polyether blocks in the composition makes it possible to lower the density of the composition.

PEBAs result from the polycondensation of polyamide blocks (rigid or hard blocks) bearing reactive ends with polyether blocks (flexible or soft blocks) bearing reactive ends, such as, inter alia, the polycondensation:
1) of polyamide blocks bearing diamine chain ends with polyoxyalkylene blocks bearing dicarboxyl chain ends;
2) of polyamide blocks bearing dicarboxyl chain ends with polyoxyalkylene blocks bearing diamine chain ends, which are obtained, for example, by cyanoethylation and hydrogenation of aliphatic α,ω-dihydroxyl polyoxyalkylene blocks, known as polyetherdiols;
3) of polyamide blocks bearing dicarboxyl chain ends with polyetherdiols, the products obtained being, in this specific case, polyetheresteramides.

The polyamide blocks bearing dicarboxyl chain ends originate, for example, from the condensation of polyamide precursors in the presence of a dicarboxylic acid chain limiter. The polyamide blocks bearing diamine chain ends originate, for example, from the condensation of polyamide precursors in the presence of a diamine chain limiter.

The polyamide blocks of the PEBA according to the invention (i.e. the nature of the polyamide) may be such as the polyamides described in the preceding section, in relation to the polyamide comprising amine chain ends (whether the polyamide blocks of the PEBA originate from polyamide blocks bearing diamine chain ends or bearing dicarboxylic chain ends). In particular, use may advantageously be made of three types of polyamide blocks corresponding to the three types of polyamides described above.

More particularly, the polyamide blocks of the copolymer used in the invention may comprise blocks of polyamide PA 6, PA 10, PA 11, PA 12, PA 5.4, PA 5.9, PA 5.10, PA 5.12, PA 5.13, PA 5.14, PA 5.16, PA 5.18, PA 5.36, PA 6.4, PA 6.6, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, or mixtures or copolymers thereof.

Preferably, the polyamide blocks of the copolymer comprise blocks of polyamide PA 6, PA 10, PA 11, PA 12, PA 6.10, PA 6.12, PA 10.10, PA 10.12, or mixtures or copolymers thereof, more preferentially blocks of polyamide PA 11, PA 12, PA 6, PA 6.12, or mixtures or copolymers thereof.

The polyether blocks consist of alkylene oxide units. The polyether blocks may notably be PEG (polyethylene glycol) blocks, i.e. blocks consisting of ethylene oxide units, and/or PPG (propylene glycol) blocks, i.e. blocks consisting of propylene oxide units, and/or PO3G (polytrimethylene glycol) blocks, i.e. blocks consisting of polytrimethylene glycol ether units, and/or PTMG (polytetramethylene glycol) blocks, i.e. blocks consisting of tetramethylene glycol units, also known as polytetrahydrofuran. The copolymers may comprise in their chain several types of polyethers, the copolyethers possibly being in block or random form.

Use may also be made of blocks obtained by oxyethylation of bisphenols, such as, for example, bisphenol A. The latter products are described in particular in document EP 613919.

The polyether blocks may also consist of ethoxylated primary amines. As examples of ethoxylated primary amines, mention may be made of the products of formula:

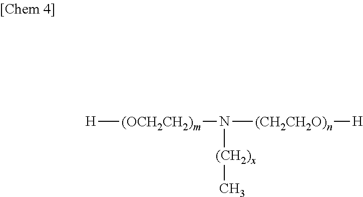

in which m and n are integers of between 1 and 20 and x is an integer of between 8 and 18. These products are, for example, commercially available under the Noramox® brand name from CECA and under the Genamin® brand name from Clariant.

The polyether flexible blocks may comprise polyoxyalkylene blocks bearing NH₂ chain ends, such blocks being able to be obtained by cyanoacetylation of α,ω-dihydroxylated aliphatic polyoxyalkylene blocks referred to as polyetherdiols. More particularly, the Jeffamine or Elastamine commercial products can be used (for example, Jeffamine® D400, D2000, ED 2003 or XTJ 542, which are commercial products from Huntsman, also described in documents JP 2004/346274, JP 2004/352794 and EP 1482 011).

The polyether diol blocks are either used in unmodified form and copolycondensed with carboxyl-terminated rigid blocks, or are aminated in order to be converted into polyetherdiamines and condensed with carboxyl-terminated rigid blocks.

The general method for the two-step preparation of the PEBA copolymers having ester bonds between the PA blocks and the PE blocks is known and is described, for example, in document FR 2846332. The general method for preparing PEBA copolymers bearing amide bonds between the PA blocks and the PE blocks is known and described, for example in EP 1 482 011. The polyether blocks can also be mixed with polyamide precursors and a diacid chain limiter in order to prepare polymers comprising polyamide blocks and polyether blocks having randomly distributed units (one-step process).

Needless to say, the name PEBA in the present description of the invention relates not only to the Pebax® products sold by Arkema, to the Vestamid® products sold by Evonik® and to the Grilamid® products sold by EMS, but also to the Pelestat® type PEBA products sold by Sanyo or to any other PEBA from other suppliers.

The present invention covers copolymers comprising a single polyamide block and a single flexible block, but also copolymers comprising three, four (or even more) different blocks chosen from those described in the present description, provided that these blocks comprise at least one polyamide block and one polyether block.

For example, the copolymer may be a segmented block copolymer comprising three different types of blocks (or “triblock” copolymer), which results from the condensation of several of the blocks described above. Said triblock may for example be a copolymer comprising a polyamide block, a polyester block and a polyether block or a copolymer comprising a polyamide block and two different polyether blocks, for example a PEG block and a PTMG block. The triblock is preferably a copolyetheresteramide.

PEBA copolymers that are particularly preferred in the context of the invention are copolymers including blocks from among: PA 10 and PEG; PA 10 and PTMG; PA 11 and PEG; PA 11 and PTMG; PA 12 and PEG; PA 12 and PTMG; PA 6.10 and PEG; PA 6.10 and PTMG; PA 6 and PEG; PA 6 and PTMG; PA 6.12 and PEG; PA 6.12 and PTMG.

The number-average molar mass of the polyamide blocks in the PEBA copolymer is preferably from 400 to 20 000 g/mol, more preferentially from 500 to 10 000 g/mol. In certain embodiments, the number-average molar mass of the polyamide blocks in the PEBA copolymer is from 400 to 500 g/mol, or 500 to 600 g/mol, or from 600 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the polyether blocks is preferably from 100 to 6000 g/mol, more preferentially from 200 to 3000 g/mol. In certain embodiments, the number-average molar mass of the polyether blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molar mass can be calculated according to the equation:

$${M}_{n} = {n}_{monomer} \times {MW}_{repeating unit} / {n}_{chain limiter} + {MW}_{chain limiter}$$

The number-average molar mass of the polyamide blocks and of the polyether blocks can be measured before the copolymerization of the blocks by gel permeation chromatography (GPC).

Advantageously, the weight ratio of the polyamide blocks relative to the polyether blocks of the copolymer is from 0.1 to 20, preferably from 0.5 to 18, even more preferentially from 0.6 to 15. This weight ratio can be calculated by dividing the number-average molar mass of the polyamide blocks by the number-average molar mass of the polyether blocks. In particular, the weight ratio of the polyamide blocks relative to the polyether blocks of the copolymer may be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20.

Advantageously, the copolymer containing polyamide blocks and polyether blocks has a Shore D hardness of greater than or equal to 30. Preferably, the copolymer used in the invention has an instantaneous hardness of from 65 Shore A to 80 Shore D, more preferably from 75 Shore A to 65 Shore D, more preferentially from 80 Shore A to 55 Shore D. The hardness measurements can be carried out according to the standard ISO 7619-1.

The PEBA according to the invention may have a concentration of OH functions of from 0.002 meq/g to 0.2 meq/g, preferably from 0.005 meq/g to 0.1 meq/g, more preferably from 0.01 meq/g to 0.08 meq/g and/or a concentration of COOH functions of from 0.002 meq/g to 0.2 meq/g, preferably from 0.005 meq/g to 0.1 meq/g, more preferably from 0.01 meq/g to 0.08 meq/g. In particular, the PEBA according to the invention may have a concentration of OH functions of from 0.002 meq/g to 0.005 meq/g, or from 0.005 to 0.01 meq/g, or from 0.01 to 0.02 meq/g, or from 0.02 to 0.03 meq/g, or from 0.03 to 0.04 meq/g, or from 0.04 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.15 meq/g, or from 0.15 to 0.2 meq/g, and/or have a concentration of COOH functions of from 0.002 to 0.005 meq/g, or from 0.005 to 0.01 meq/g, or from 0.01 to 0.02 meq/g, or from 0.02 to 0.03 meq/g, or from 0.03 to 0.04 meq/g, or from 0.04 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.15 meq/g, or from 0.15 to 0.2 meq/g. The concentration of COOH functions can be determined by potentiometric analysis and the concentration of OH functions can be determined by proton NMR. Measurement protocols are described in detail in the article “Synthesis and characterization of poly(copolyethers-block-polyamides)—II. Characterization and properties of the multiblock copolymers”, Maréchal et al., Polymer, Volume 41, 2000, 3561-3580.

The PEBA according to the invention may have a concentration of NH₂ functions of from 0.01 meq/g to 1 meq/g, preferably from 0.02 meq/g to 0.4 meq/g. The PEBA may have a concentration of NH₂ functions of from 0.01 to 0.015 meq/g, or from 0.015 to 0.02 meq/g, or from 0.02 to 0.025 meq/g, or from 0.025 to 0.03 meq/g, or from 0.03 to 0.035 meq/g, or from 0.035 to 0.04 meq/g, or from 0.04 to 0.045 meq/g, or from 0.045 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.2 meq/g, or from 0.2 to 0.3 meq/g, or from 0.3 to 0.4 meq/g, or from 0.4 to 0.5 meq/g, or from 0.5 to 0.6 meq/g, or from 0.6 to 0.7 meq/g, or from 0.7 to 0.8 meq/g, or from 0.8 to 0.9 meq/g, or from 0.9 to 1 meq/g. The concentration of NH2 functions can be measured by potentiometric titration. This titration may for example be carried out in the following manner: the PEBAs are first dissolved in m-cresol at 80° C. and then the terminal NH₂ functions are titrated with a perchloric acid solution.

### TPU and PA Composition

The composition according to the invention is a blend comprising at least one PA and at least one TPU and optionally at least one PEBA. The term “blend” is understood to mean a homogeneous mixture (macroscopically homogeneous mixture, i.e. a mixture that is homogeneous to the naked eye).

Preferably, the amount of polyamide comprising amine chain ends in the composition is less than or equal to 40% by weight, preferably less than or equal to 30% by weight.

More preferentially, the composition according to the invention comprises from 1% to 40% by weight of at least one polyamide comprising amine chain ends and from 60% to 99% by weight of at least one thermoplastic polyurethane, preferably from 1% to 30% by weight of at least one polyamide comprising amine chain ends and from 70% to 99% by weight of at least one thermoplastic polyurethane, preferably from 1% to 25% by weight of at least one polyamide comprising amine chain ends and from 75% to 99% by weight of at least one thermoplastic polyurethane, more preferentially from 1.5% to 25% by weight of at least one polyamide with amine chain ends, and from 75% to 98.5% by weight of at least one thermoplastic polyurethane, even more preferentially from 2% to 20% by weight of at least one polyamide comprising amine chain ends and from 80% to 98% by weight of at least one thermoplastic polyurethane, relative to the total weight of the polyamide comprising amine chain ends and the thermoplastic polyurethane. When the polyamide and the TPU are present in the above ranges, the elasticity of the composition is improved. In embodiments, the composition comprises from 1% to 5% by weight of at least one polyamide comprising amine chain ends and from 95% to 99% by weight of at least one thermoplastic polyurethane, or from 5% to 10% by weight of at least one polyamide comprising amine chain ends and from 90% to 95% by weight of at least one thermoplastic polyurethane, or from 10% to 15% by weight of at least one polyamide comprising amine chain ends and from 85% to 90% by weight of at least one thermoplastic polyurethane, or from 15% to 20% by weight of at least one polyamide comprising amine chain ends and from 80% to 85% by weight of at least one thermoplastic polyurethane, or from 20% to 25% by weight of at least one polyamide comprising amine chain ends and from 75% to 80% by weight of at least one thermoplastic polyurethane, or from 25% to 30% by weight of at least one polyamide comprising amine chain ends and from 70% to 75% by weight of at least one thermoplastic polyurethane, or from 30% to 35% by weight of at least one polyamide comprising amine chain ends and from 65% to 70% by weight of at least one thermoplastic polyurethane, or from 35% to 40% by weight of at least one polyamide comprising amine chain ends and from 60% to 65% by weight of at least one thermoplastic polyurethane, relative to the total weight of the polyamide comprising amine chain ends and the thermoplastic polyurethane.

The composition according to the invention advantageously comprises from 1% to 40% by weight of at least one polyamide comprising amine chain ends and from 10% to 99% by weight of at least one thermoplastic polyurethane, preferably from 1% to 30% by weight of at least one polyamide comprising amine chain ends and from 15% to 89% by weight of at least one thermoplastic polyurethane, more preferably from 1% to 25% by weight of at least one polyamide comprising amine chain ends and from 15% to 89% by weight of at least one thermoplastic polyurethane. The composition may comprise from 1% to 5%, or from 5% to 10%, or from 10% to 15%, or from 15% to 20%, or from 20% to 25%, or from 25% to 30%, or from 30% to 35%, or from 35% to 40%, by weight, of at least one polyamide comprising amine chain ends, relative to the total weight of the composition. The composition may comprise from 10% to 20%, or from 20% to 30%, or from 30% to 40%, or from 40% to 50%, or from 50% to 60%, or from 60% to 70%, or from 70% to 80%, or from 80% to 90%, or from 90% to 99%, by weight, of at least one thermoplastic polyurethane, relative to the total weight of the composition.

The composition may also comprise at least one PEBA, advantageously in an amount, relative to the total weight of the composition, of from 0 to 89% by weight, more preferentially from 10% to 70% by weight. In particular, the composition may comprise from 0 to 10%, or from 10% to 20%, or from 20% to 30%, or from 30% to 40%, or from 40% to 50%, or from 50% to 60%, or from 60% to 70%, or from 70% to 80%, or from 80% to 89%, by weight, of PEBA, relative to the total weight of the composition. The composition may be free of a copolymer containing polyamide blocks and polyether blocks. The above ranges of the amount of PEBA can each be combined with any of the ranges of the amount of polyamide comprising amine chain ends and/or any of the ranges of the amount of thermoplastic polyurethane mentioned above.

The molar ratio of the urethane functions to the NH₂ amine functions of the assembly consisting of at least one polyamide comprising amine chain ends and of at least one thermoplastic polyurethane, in the composition according to the invention, may be from 15 to 350, preferably from 25 to 250, even more preferably from 40 to 200. The concentrations of amine functions and urethane functions can be determined by NMR according to the conditions described in the article below: “Reactivity of isocyanates with urethanes: Conditions for allophanate formation”, Lapprand et al., Polymer Degradation and Stability, Volume 90, No. 2, 2005, 363-373.

The composition according to the invention may consist of the at least one polyamide comprising amine chain ends, of the at least one thermoplastic polyurethane and optionally of the at least one copolymer containing polyamide blocks and polyether blocks.

Alternatively, the composition may comprise one or more additives, preferably chosen from impact modifiers, functional or non-functional polyolefins, copolyetheresters, ethylene/vinyl acetate copolymers, ethylene/acrylate copolymers, ethylene/alkyl (meth)acrylate copolymers, copolymers comprising ethylene and styrene, polyorganosiloxanes, plasticizers, nucleating agents, lubricants, mold-release agents, dyes, pigments, organic or inorganic fillers, reinforcing agents, flame retardants, UV absorbers, optical brighteners, light stabilizers, antioxidants and mixtures thereof. Advantageously, the additives are present in an amount of from 0.1% to 20% by weight, preferably from 0.2% to 10% by weight, relative to the total weight of the composition.

The composition according to the invention preferably has a tensile modulus at 23° C. of less than or equal to 1000 MPa. More preferably, the composition according to the invention has a tensile modulus at 23° C. of less than or equal to 800 MPa, more preferentially of less than or equal to 500 MPa. The tensile modulus of the composition can be determined according to the standard ISO 527-1A. The tensile modulus at 23° C. of the composition may be from 20 to 40 MPa, or from 40 to 60 MPa, or from 60 to 80 MPa, or from 80 to 100 MPa, or from 100 to 150 MPa, or from 150 to 200 MPa, or from 200 to 250 MPa, or from 250 to 300 MPa, or from 300 to 350 MPa, or from 350 to 400 MPa, or from 400 to 450 MPa, or from 450 to 500 MPa, or from 500 to 550 MPa, or from 550 to 600 MPa, or from 600 to 700 MPa, or from 700 to 800 MPa, or from 800 to 900 MPa, or from 900 to 1000 MPa.

Preferably, the weight amount of total flexible blocks (i.e. flexible blocks of the thermoplastic polyurethane and of the PEBA when the latter is present) is from 20% to 90%, more preferentially from 40% to 80%, even more preferentially from 50% to 75%, relative to the total weight of TPU and PEBA if present. The weight amount of total flexible blocks can be determined by nuclear magnetic resonance (NMR).

Advantageously, the composition has a tan δ at 23° C. of less than or equal to 0.18, preferably less than or equal to 0.16, more preferably less than or equal to 0.14. The tan δ (or loss factor) at 23° C. corresponds to the ratio of the loss modulus E″ to the modulus of elasticity E′ measured at a temperature of 23° C. by dynamic mechanical analysis (DMA). It can be measured according to the standard ISO 6721 from 2019, the measurement being carried out at a tensile strain of 0.1%, at a frequency of 1 Hz, and at a heating rate of 2° C./min. The tan δ makes it possible to characterize the elasticity of the composition: the lower the tan δ, the greater the elastic recovery. The tan δ at 23° C. of the composition may be from 0.04 to 0.05, or from 0.05 to 0.06, or from 0.06 to 0.07, or from 0.07 to 0.08, or from 0.08 to 0.09, or from 0.09 to 0.10, or from 0.10 to 0.11, or from 0.11 to 0.12, or from 0.12 to 0.13, or from 0.13 to 0.14, or from 0.14 to 0.15, or from 0.15 to 0.16, or from 0.16 to 0.17, or from 0.17 to 0.18.

The composition according to the invention preferably has a density of less than or equal to 1.2, more preferentially of less than or equal to 1.18. The density of the composition can be determined according to the ISO 1183-1 standard. In embodiments, the composition may have a density of from 1.00 to 1.01, or from 1.01 to 1.02, or from 1.02 to 1.03, or from 1.03 to 1.04, or from 1.04 to 1.05, or from 1.05 to 1.06, or from 1.06 to 1.07, or from 1.07 to 1.08, or from 1.08 to 1.09, or from 1.09 to 1.10, or from 1.10 to 1.11, or from 1.11 to 1.12, or from 1.12 to 1.13, or from 1.13 to 1.14, or from 1.14 to 1.15, or from 1.15 to 1.16, or from 1.16 to 1.17, or from 1.17 to 1.18, or from 1.18 to 1.19, or from 1.19 to 1.2.

The composition preferably has a Shore A hardness of from 70 to 98, more preferably from 75 to 95. The hardness measurements are carried out according to the ISO 7619-1 standard.

The composition is advantageously in the form of granules. Alternatively, it may be in powder form.

Advantageously, the composition of TPU and PA according to the invention comprises at least one portion of polyamide covalently bonded to at least one portion of thermoplastic polyether by a urea function. Preferably, the composition according to the invention has a concentration of urea functions of from 0.001 meq/g to 0.1 meq/g, preferably from 0.003 meq/g to 0.08 meq/g, more preferably from 0.005 meq/g to 0.05 meq/g. The concentration of urea functions can be determined by NMR according to the conditions described in the article below: “Reactivity of isocyanates with urethanes: Conditions for allophanate formation”, Lapprand et al., Polymer Degradation and Stability, Volume 90, No. 2, 2005, 363-373.

Preferably, the portion of the polyamide covalently bonded to at least one portion of the thermoplastic polyurethane by a urea function represents 10% or less by weight, more preferably 5% or less by weight, more preferably 3% or less by weight, more preferentially 2% or less by weight, of the amount of the polyamide.

According to another aspect, the invention relates to a composition obtained by the reaction of at least one polyamide comprising amine chain ends, and at least one thermoplastic polyurethane or thermoplastic polyurethane precursors. The characteristics described above can be applied in a similar manner to this aspect of the invention. Thus, in particular, the amounts in the composition of the at least one polyamide comprising amine chain ends and of the at least one thermoplastic polyurethane described above can be applied, respectively, to the amount of the at least one polyamide comprising amine chain ends and to the amount of the at least one thermoplastic polyurethane or thermoplastic polyurethane precursors reacted. The composition advantageously has a tensile modulus at 23° C. of less than or equal to 1000 MPa.

### Preparation Processes

The invention also relates to a process for preparing a composition as described above.

According to a first advantageous variant, the composition according to the invention can be prepared by a process comprising a step of mixing at least one polyamide comprising amine chain ends in the melt state and at least one thermoplastic polyurethane in the melt state, and optionally at least one copolymer containing polyamide blocks and polyether blocks in the melt state. Such a preparation process makes it possible, under certain mixing time and temperature conditions, for a reaction to take place between the amine functions of a portion of the polyamide and the urethane functions of the TPU, which improves the compatibility between the polyamide and the thermoplastic polyurethane.

Advantageously, the amount of polyamide comprising amine chain ends in the melt state that is mixed is from 1% to 40% by weight, preferably from 1% to 30% by weight, the amount of the thermoplastic polyurethane in the melt state that is mixed is from 10% to 99% by weight, preferably from 15% to 89% by weight, and the amount of copolymer containing polyamide blocks and polyether blocks is from 0 to 89% by weight, preferably from 10% to 70% by weight, relative to the total weight of the composition.

The mixing can take place in any device for mixing, kneading or extruding plastics in the melt state known to those skilled in the art, such as an internal mixer, an open mill, an extruder, such as a single-screw extruder or a counter-rotating or co-rotating twin-screw extruder, a co-kneader, such as a continuous co-kneader, or a stirred reactor. Preferably, the mixing takes place in an extruder or a co-kneader, more preferentially in an extruder, even more preferentially in a twin-screw extruder.

Preferably, the mixing is carried out at a temperature above or equal to 160° C., preferably from 160° C. to 300° C., more preferably from 180° C. to 260° C. These temperature ranges allow an optimal reaction between the polyamide comprising amine chain ends and the thermoplastic polyurethane, and therefore a better compatibility of the two polymers.

Advantageously, the mixing is carried out for a period of from 30 seconds to 15 minutes, preferably from 40 seconds to 10 minutes. Preferably, the mixing is carried out with stirring. These mixing conditions allow an optimum reaction between the polyamide comprising amine chain ends and the thermoplastic polyurethane, and therefore a better compatibility of the two polymers.

The polyamide comprising amine chain ends, the thermoplastic polyurethane and optionally the copolymer containing polyamide blocks and polyether blocks can independently be, before being melt-blended, in the form of powder or granules.

The mixing step may comprise mixing the polyamide comprising amine chain ends, the thermoplastic polyurethane and optionally the copolymer containing polyamide blocks and polyether blocks, in the melt state, with other constituents of the composition (for example additives).

Advantageously, the preparation process comprises a step of shaping the mixture in the form of granules or powder.

When the mixture is formed into powder, it is preferably first formed into granules and then the granules are ground to powder. Any type of mill can be used, such as a hammer mill, a pin mill, an attrition disk mill or an impact classifier mill.

Preferably, the mixture is formed into granules.

According to another advantageous variant, the composition may be prepared by introducing at least one polyamide comprising amine chain ends and optionally at least one copolymer containing polyamide blocks and polyether blocks during the synthesis of at least one thermoplastic polyurethane. In such a preparation process, the polyamide comprising amine chain ends, and optionally the copolymer containing polyamide blocks and polyether blocks, are used as isocyanate-reactive compounds (as described above in the “Thermoplastic polyurethane (TPU)” section), optionally in addition to another isocyanate-reactive compound, preferably a polyol as described above, and/or a chain extender as described above.

Thus, the preparation process may comprise the steps of:
introducing the precursors of the thermoplastic polyurethane (i.e. at least one polyisocyanate, optionally at least one isocyanate-reactive compound and optionally at least one chain extender) into a reactor;
introducing the polyamide comprising amine chain ends into the reactor;
optionally introducing the copolymer containing polyamide blocks and polyether blocks into the reactor;
synthesizing the thermoplastic polyurethane in the reactor in the presence of the polyamide comprising amine chain ends (and optionally the copolymer containing polyamide blocks and polyether blocks), so as to obtain a composition of thermoplastic polyurethane and polyamide (and optionally of a copolymer containing polyamide blocks and polyether blocks).

Such a preparation process enables the reaction of a portion of the NH₂ amine functions of the polyamide with the isocyanate functions of a portion of the polyisocyanate during the synthesis of the thermoplastic polyurethane, leading to the formation of covalent bonds between the polyamide and the thermoplastic polyurethane, which improves the compatibility between the polyamide and thermoplastic polyurethane.

Advantageously, the amount of polyamide comprising amine chain ends introduced into the reactor is from 1% to 40% by weight, preferably from 1% to 30% by weight, the amount of the thermoplastic polyurethane introduced into the reactor is from 10% to 99% by weight, preferably from 15% to 89% by weight, and the amount of copolymer containing polyamide blocks and polyether blocks introduced into the reactor is from 0 to 89% by weight, preferably from 10% to 70% by weight, relative to the total weight of the composition.

The steps of introducing the precursors of the thermoplastic polyurethane, of introducing the polyamide comprising amine chain ends and of introducing the copolymer containing polyamide blocks and polyether blocks may be simultaneous or carried out in any order. A catalyst, in particular as described above, may also be introduced into the reactor.

The reactor may be a batch reactor, a stirred reactor, a static mixer, an internal mixer, an open mill, an extruder, such as a single-screw extruder or a counter-rotating or co-rotating twin-screw extruder, a continuous co-kneader, or a combination thereof. Preferably, the reactor is an extruder, more preferably a twin-screw extruder.

Preferably, the step of synthesizing the thermoplastic polyurethane (in the presence of the polyamide comprising amine chain ends and optionally the copolymer containing polyamide blocks and polyether blocks) is carried out at a temperature above or equal to 160° C., preferably from 160° C. to 300° C., more preferably from 180° C. to 270° C. These temperature ranges allow an optimal reaction between the polyamide comprising amine chain ends and the thermoplastic polyurethane, and therefore a better compatibility of the two polymers.

The process may comprise the introduction into the reactor of one or more additives, and the mixing thereof with the thermoplastic polyurethane, the polyamide comprising amine chain ends, and optionally the copolymer containing polyamide blocks and polyether blocks, in the reactor.

Preferably, the preparation process comprises a step of shaping the composition in the form of granules or powder, more preferentially in the form of granules. The composition may be formed into powder in the manner described above in relation to the first variant of the preparation process.

In these preparation processes, all the characteristics described above in relation to the polyamide comprising amine chain ends, the thermoplastic polyurethane and the copolymer containing polyamide blocks and polyether blocks (in particular the nature thereof, the amount thereof, etc.) can be applied in a similar manner.

Generally, during the preparation of the composition, it is possible to reduce the tensile modulus at 23° C. of the composition:
by increasing the number-average molar mass of the flexible blocks of the TPU (and/or of the PEBA if present);
by using as flexible blocks of the TPU (and/or of the PEBA if present) a material with a lower tensile modulus;
by reducing the weight ratio of the rigid blocks relative to the flexible blocks of the TPU (and/or of the PEBA if present);
by inducing a reaction between at least one portion of the PA comprising amine chain ends and at least one portion of the TPU.

The invention also relates to a composition obtained by, or capable of being obtained by, a preparation process as described above. The characteristics described above, in particular in the section “TPU and PA composition”, can be applied in a similar manner to this composition.

### Applications

The composition according to the invention may be used for manufacturing sports equipment, such as sports footwear soles, ski footwear, midsoles, insoles or else functional sole components, in the form of inserts in the various parts of the sole (for example the heel or the arch), or else footwear upper components in the form of reinforcements or inserts in the structure of the footwear upper, or in the form of protections.

It may also be used for producing balls, sports gloves (for example football gloves), golf ball components, rackets, protective elements (jackets, interior parts of helmets, shells, etc.).

The composition according to the invention can also be used for producing various parts:
in the optical industry: components of spectacle frames, nose pads or nosepieces, protective elements on frames; this is because the compositions of the invention have a soft-silky feel, adhere well to polyamide and more specifically to transparent polyamide by overmolding, and are resistant to sebum;
in the automotive industry: interior decorative elements; this is because the compositions of the invention have a soft feel, good haptic properties, adhere perfectly by overmolding, are sebum-resistant and abrasion-resistant;
in the manufacturing industry: transmission or conveyor belts, silent gears; this is because the compositions of the invention are heat-resistant, abrasion-resistant, and easy to process by overmolding;
in the medical sector: patches, biofeedback patches, drug delivery systems, sensors, catheters;
in the electronics industry: headset components, earphones, Bluetooth® jewelry and watches, display screens, connected watches, connected glasses, interactive game components and devices, GPS, connected footwear, bioactivity monitors and sensors, interactive belts and bracelets, child or pet tracker, pocket scanner or palmtop, location sensors, trackers or vision device;
in the transport industry: railway tie pads;
in the toy industry;
in the jewelry industry: watch straps.

The articles or components consisting of a composition as described above can be produced by injection molding.

### EXAMPLES

The following examples illustrate the invention without limiting it.

The following polymers were used:
TPU: TPU with rigid blocks based on 4,4′-MDI and 1,6-HDO (1,6-hexanediol) and with polyester flexible blocks based on adipic acid and butanediol, with a Shore A hardness of 95.
PA no. 1: polyamide 11 containing on average one amine chain end per molecule, and having a concentration of NH₂ functions of 0.476 meq/g.
PA no. 2: polyamide 6/6.6/12 (40/25/35 by weight) comprising amine chain ends, and having a concentration of NH₂ functions of 0.305 meq/g.
PEBA no. 1: PEBA copolymer comprising rigid blocks of PA 11 with a number-average molar mass of 1000 g/mol and blocks of PTMG with a number-average molar mass of 1000 g/mol.
PEBA no. 2: PEBA copolymer comprising rigid blocks of PA 11 with a number-average molar mass of 4000 g/mol and flexible blocks of PTMG with a number-average molar mass of 1000 g/mol.

Various compositions were prepared. The amounts of their constituents are indicated as weight percentages in the tables below.

TABLE 1

| | Composition No. | | | | |
|---|---|---|---|---|---|
| | 1 | 2 | 3 | 4 | 5 |
| TPU | 85 | 45 | 40 | 35 | 45 |
| PA No. 1 | 15 | 10 | 20 | 30 | |
| PA No. 2 | | | | | 10 |
| PEBA No. 1 | | 45 | 40 | 35 | 45 |
| PEBA No. 2 | | | | | |

TABLE 2

| | Composition No. | | | | | |
|---|---|---|---|---|---|---|
| | 6 | 7 | 8 | 9 | 10 | 11 |
| TPU | 40 | 35 | 40 | 100 | 50 | 50 |
| PA No. 1 | | | 20 | | | |
| PA No. 2 | 20 | 30 | | | | |
| PEBA No. 1 | 40 | 35 | | | 50 | |
| PEBA No. 2 | | | 40 | | | 50 |

All the above compositions were produced using a 18 mm ZSK twin-screw extruder (Coperion). The temperature of the barrels was set to 210° C. and the screw speed was 280 rpm with a throughput of 8 kg/h.

The compositions were then dried under reduced pressure at 80° C. in order to achieve a moisture content of less than 0.04%.

1A test specimens (according to ISO 527) and 2 mm sheets were produced by injection molding using a Battenfeld BA800 CDC press using unpolished molds. The following parameters were applied during injection:
Barrel temperature: 180° C.
Nozzle temperature: 200° C.
Mold temperature: 30° C.
Cycle time: 60 seconds.

Compositions No. 1 to No. 8 are compositions according to the invention, compositions No. 9, No. 10 and No. 11 are comparative compositions.

Various properties of these compositions were evaluated:
the tensile modulus at 23° C.: measured according to the standard ISO 527-1A;
the stress at 50% strain at 23° C.: measured according to the standard ISO 527-1A;
the elongation at break at 23° C.: measured according to the standard ISO 527-1A;
the stress at break at 23° C.: measured according to the standard ISO 527-1A;
the density at 23° C.: measured according to the standard ISO 1183-1;
the Shore A hardness at 23° C.: measured after 3 s according to the standard ISO 7619-1;
the tan δ at 23° C.: measured according to the standard ISO 6721 from 2019, at a tensile strain of 0.1%, at a frequency of 1 Hz, and at a heating rate of 2° C./min.

All these evaluations were carried out on dry (unconditioned) test specimens.

The results are presented in the tables below.

TABLE 3

| | Composition No. | | | | |
|---|---|---|---|---|---|
| | 1 | 2 | 3 | 4 | 5 |
| Tensile modulus | 296.0 | 179.4 | 257.0 | 453.6 | 81.5 |
| (MPa) | | | | | |
| Stress at 50% (MPa) | 12.8 | 10.7 | 12.5 | — | 8.5 |
| Elongation at break | 284.2 | 591.8 | 210.8 | 16.6 | 615.0 |
| (%) | | | | | |
| Stress at break (%) | 15.8 | 22.2 | 12.0 | 16.0 | 25.0 |
| Density | 1.169 | 1.097 | 1.090 | 1.082 | 1.096 |
| Shore A hardness | 97 | 95 | 95 | 96 | 95 |
| Tan δ at 23° C. | 0.080 | 0.068 | 0.056 | 0.044 | 0.082 |

TABLE 4

| | Composition No. | | | | | |
|---|---|---|---|---|---|---|
| | 6 | 7 | 8 | 9 | 10 | 11 |
| Tensile modulus | 89.2 | 121.2 | 362.6 | 115.8 | 69.8 | 185.4 |
| (MPa) | | | | | | |
| Stress at 50% | 8.3 | 8.2 | 19.7 | 9.7 | 7.7 | 15.1 |
| (MPa) | | | | | | |
| Elongation at | 446.4 | 421.0 | 431.6 | 635.2 | 750.3 | 520.2 |
| break (%) | | | | | | |
| Stress at break (%) | 21.0 | 20.1 | 26.6 | 55.1 | 41.0 | 40.4 |
| Density | 1.088 | 1.082 | 1.094 | 1.203 | 1.103 | 1.104 |
| Shore A hardness | 95 | 95 | 96 | 94 | 93 | 95 |
| Tan δ at 23° C. | 0.069 | 0.051 | 0.10 | 0.18 | 0.099 | 0.14 |

It is found that composition No. 1 has a tan δ much lower than that of composition No. 9. Similarly, compositions No. 2, No. 3 and No. 4 have a loss factor (tan δ) lower than that of composition No. 10 and composition No. 8 has a loss factor (tan δ) lower than that of composition No. 11. The addition of a polyamide with NH₂ chain ends thus makes it possible to increase the elasticity of the composition.

In addition, the presence of a copolymer containing polyamide blocks and polyether blocks in the composition, in addition to the polyamide with NH₂ chain ends, makes it possible to achieve a lower density.

It is also observed that the compositions comprising PA No. 1, which has a concentration of NH₂ functions greater than that of PA No. 2, have a lower tan δ (and are therefore more elastic) than the compositions comprising PA No. 2.

1. A composition comprising:
at least one thermoplastic polyurethane, and
at least one polyamide containing amine chain ends,
wherein the polyamide is the reaction product of one or more monomers chosen from amino acids or aminocarboxylic acids, lactams and monomers resulting from the reaction between an aliphatic diamine and a dicarboxylic acid.

2. A composition obtained by the reaction of:
at least one thermoplastic polyurethane or thermoplastic polyurethane precursors, and
at least one polyamide containing amine chain ends,
wherein the polyamide is the reaction product of one or more monomers chosen from amino acids or aminocarboxylic acids, lactams and monomers resulting from the reaction between an aliphatic diamine and a dicarboxylic acid.

3. The composition as claimed in claim 1, wherein at least one portion of the polyamide is covalently bonded to at least one portion of the thermoplastic polyurethane by a urea function.

4. The composition as claimed in claim 1, wherein the polyamide has a concentration of NH₂ amine functions of from 0.02 meq/g to 2.0 meq/g.

5. The composition as claimed in claim 1, having a tensile modulus at 23° C. of less than or equal to 1000 MPa.

6. The composition as claimed in claim 1, further comprising at least one copolymer containing polyamide blocks and polyether blocks-.

7. The composition as claimed in claim 1, wherein the at least one polyamide comprising amine chain ends is present in an amount of less than or equal to 40% by weight, relative to the total weight of the composition.

8. The composition as claimed in claim 1, comprising, relative to the total weight of the composition:
from 10% to 99% by weight, of at least one thermoplastic polyurethane,
from 1% to 40% by weight, of at least one polyamide with amine chain ends, and
from 0 to 89%, of at least one copolymer containing polyamide blocks and polyether blocks.

9. The composition as claimed in claim 1, having a tan δ at 23° C. of less than or equal to 0.18.

10. The composition as claimed in claim 1, wherein the polyamide comprising amine chain ends has a number-average molar mass of from 1000 to 60 000 g/mol.

11. The composition as claimed in ene claim 1, wherein the thermoplastic polyurethane is a copolymer containing rigid blocks and flexible blocks, wherein:
the flexible blocks are chosen from polyether blocks, polyester blocks, polycarbonate blocks and a combination thereof; and/or
the rigid blocks comprise units derived from diphenylmethane-4,4′-diisocyanate and/or from hexamethylene-1,6-diisocyanate.

12. The composition as claimed in claim 1, wherein the polyamide comprising amine chain ends is chosen from the group consisting of polyamide 11, polyamide 12, polyamide 10, polyamide 6, polyamide 6.10, polyamide 6.6, polyamide 10.10, polyamide 10.12 and combinations thereof.

13. The composition as claimed in claim 1, wherein the polyamide has a concentration of COOH functions of from 0.002 meq/g to 0.2 meq/g.

14. A process for preparing a composition, comprising the following steps:
mixing, at least one polyamide comprising amine chain ends in the melt state, at least one thermoplastic polyurethane in the melt state and optionally at least one copolymer containing polyamide blocks and polyether blocks in the melt state, the polyamide comprising amine chain ends being the reaction product of one or more monomers chosen from amino acids or aminocarboxylic acids, lactams and monomers resulting from the reaction between an aliphatic diamine and a dicarboxylic acid; and
optionally, shaping the mixture in the form of granules or powder.

15. A process for preparing a composition, comprising the following steps:
introducing into a reactor, precursors of at least one thermoplastic polyurethane;
introducing into the reactor at least one polyamide comprising amine chain ends and optionally at least one copolymer containing polyamide blocks and polyether blocks, the polyamide comprising amine chain ends being the reaction product of one or more monomers chosen from amino acids or aminocarboxylic acids, lactams and monomers resulting from the reaction between an aliphatic diamine and a dicarboxylic acid;
synthesizing the thermoplastic polyurethane in the reactor in the presence of the polyamide comprising amine chain ends, so as to obtain a composition made of thermoplastic polyurethane and of polyamide;
optionally, shaping the composition in the form of granules or powder.

16. An article consisting of, or comprising at least one element consisting of a composition as claimed in claim 1.

17. A process for manufacturing an article as claimed in claim 16, comprising the following steps:
supplying the composition;
injection molding said composition.
